(19) United States
(12) Patent Application Publication
(10) Pub. No.: US 2014/0317593 A1
(43) Pub. Date: Oct. 23, 2014

(54) HIGHLY EXTENSIBLE REQUIREMENT ANALYSIS METHOD AND SYSTEM OF THE SAME

(71) Applicant: PO-HSUN CHENG, (US)

(72) Inventors: PO-HSUN CHENG, KAOHSIUNG CITY (TW); HSIN-CHIANG CHANG, YILAN COUNTY (TW); FU-HAN CHANG, KAOHSIUNG CITY (TW)

(73) Assignee: PO-HSUN CHENG, KAOHSIUNG CITY (TW)

(21) Appl. No.: 13/866,370

(22) Filed: Apr. 19, 2013

(51) Int. Cl. G06F 9/44

(52) U.S. Cl. CPC G06F 8/10
USPC 717/104

(57) ABSTRACT

A highly extensible requirements analysis method and a system of the same are revealed. First collect user requirements of a software system and modify the user requirements by a breadth analysis tool and a depth analysis tool. Then generate actors that interact with the software system and collect more actors by the breadth analysis and depth analysis tools so as to make the actors with breadth and depth. Next generate use case diagrams of respective actor according to the above user requirements and the actors. Finally, the use case diagrams are modified by the breadth analysis and depth analysis tools so that the use case diagrams have breadth and depth. Thereby the user requirements of the software system are collected quickly and defined precisely at the requirements analysis and definition stages. The software development efficiency is improved and the cost is reduced.

### BACKGROUND OF THE INVENTION

1. Fields of the Invention

The present invention relates to a highly extensible requirements analysis method and a system of the same, especially to a highly extensible requirements analysis method and a system of the same that use a breadth analysis tool/module and a depth analysis tool/module to actively elicit abnormal conditions and unexpected user requirements based on the conventional single dimensional requirements analysis method. This three-dimension requirements analysis method allows user requirements to be collected quickly and defined precisely so that the software development efficiency is improved and the development cost is reduced.

2. Descriptions of Related Art

A plurality of conditions needs to be satisfied during software development process and the software developed should meet user requirements. Thus the software development speed and quality are affected by many factors during the development process. Generally, the software development includes following steps: requirements analysis, requirements definition (such as Object-Oriented Analysis; OOA), system design (such as Object-Oriented Design; OOD), and programming and testing. During the requirements analysis and requirements definition processes, customers state their functional requirements for software. Then software analysts gather and record general user requirements and the requirements are documented. Next system design process is performed. The system developers do the system analysis and following program coding according to documents and diagrams set up by the analysts.

However, users/customers always have only an abstract idea and their descriptions of the requirements are incomplete and ambiguous. The analysis engineers' recognition of these requirements is not clear and precise. There are certain errors between the document/diagram produced and user requirements. The system developers can only do the system analysis according to the documents and diagrams with certain errors. Moreover, the system developers may have errors in understanding of these documents and diagrams. Thus the software developed is unable to meet the user requirements. It takes enormous time and money to modify the software. Thus the later the errors are discovered during the processes of requirements analysis, requirements definition, system design, programming, and testing, the higher the cost of software modification. Thus the great cost of software development can be saved once the requirements can be checked and confirmed precisely during the requirements analysis and requirements definition processes. Furthermore, with the rapidly changing business environment, the system set-up from understanding of users' requirements to system analysis and design is time-consuming. The users' requirements have been changed before completing the software. Therefore how to shift the focus of the software development from later stages including system design and programming) to earlier ones such as requirements analysis and definition has become an important issue for today's software industry.

Due to importance of the requirements analysis, several methods such as the Unified Modeling Language (URL) and tools such as use cases and data modeling have been developed and applied to requirements analysis in software engineering. The requirements analysis method available now generally includes following three steps: step (a) collect user requirements. Users express their requirements for software functions while analysts describe procedures of each operation of the software system and how to deal with abnormal condition of each function. Analysts can even point out possible limitations on system development and describe possible interactions between the software system and an external system in future. Step (b) Generate actors that interact with the software system and collect requirements of primary or secondary actors for categorizing and analysis. And step (c) Generate use cases. According to the requirements collected in the step (a) and (b), the use case that shows how each actor interact with the system. And the use case is cut and divided into parts with proper size according to procedures of each function.

However, the requirements analysis mentioned above is a single dimensional analysis method and only technical features (functions) appeared most frequently on documents or during discussion are considered as important features while other features still known but not so significant are neglected. For example, some techniques mentioned a little bit are not the most important features on documents so that analysts usually can't collect and categorize theses techniques (or intentionally not to do so). Thus the setup and confirmation of the user requirements take enormous time in interview and discussion. Moreover, the analysts not only need to collect the user requirements effectively but also have ability of active elicitation. For example, users always focus on normal and expected conditions of the software system while describing their requirements and this causes complication or difficulty in software development such as processing of abnormal conditions. Thus the analyst should actively propose problems regarding unexpected conditions such as what exceptions may occur, how users deal with the exceptions, etc., so as to determine how to deal with expected abnormality of the system. Therefore the analyst needs to have years of experience in software development. Yet different analysts generate different results of requirements analysis. Thus the analyst plays a key role in software system development. For design companies in software industry, they do need an organized requirements analysis method with breadth and depth for collecting user requirements rapidly and precisely, lowering development cost of the software system, and reducing modification frequency. Furthermore, the completed software meets the user requirements more closely so that the time and cost of modifying the software are minimized.

In order to make the requirements analysis and requirements definition more objective and precise, there is a need to develop a novel requirements analysis method and a system of the same that solve the above problems.

### SUMMARY OF THE INVENTION

Therefore it is a primary object of the present invention to provide a highly extensible requirements analysis method and a system of the same that use a breadth analysis tool and a depth analysis tool (module) to elicit abnormal conditions and unexpected user requirements based on the conventional single dimensional requirements analysis method. Thus the user requirements can be collected quickly and the requirements are defined quickly and precisely at the requirements analysis and requirements definition stages during the software system. Therefore the software development efficiency is improved and the development cost is reduced.

In order to achieve the above objects, a requirements analysis method of the present invention includes a plurality of steps. First collect user requirements of a software system to be set up and modify the user requirements by a breadth analysis tool and a depth analysis tool in turn so as to get the user requirements with breadth and depth. Then generate actors that interact with the software system according to the user requirements completed in the above step. Later use the breadth analysis tool and the depth analysis tool in turn to collect more actors so as to make the actors with breadth and depth. At last, generate use case diagrams of respective actor that interact with the software system according to the user requirements and the actors completed in the above steps. Next the use case diagrams are modified by the breadth analysis tool and the depth analysis tool in turn so that the use case diagrams have breadth and depth. Thereby the breadth analysis tool and the depth analysis tool are used in each of the three steps of the requirements analysis method to elicit abnormal conditions and unexpected user requirements actively. Thereby the three-dimensional requirements analysis method of the present invention can solve the shortcoming of conventional single dimensional analysis method that only technical features or functions appeared the most times on the documents or during the discussion can be found out. Thus the analysts can understand user requirements more precisely. Therefore the chance of the software system to be modified again is reduced and the software development cost is decreased.

The above breadth analysis tool is based on a PMI (Plus, Minus, and Interesting) method and the depth analysis tool is based on APC (Alternatives, Possibilities, and Choices) method. The actors can users of the software system or users of an external system.

After completing the above step/steps including collecting user requirements of a software system to be set up (step one), generating actors that interact with the software system (step two), and generating use case diagrams of the actors that interact with the software system (step three), the analyst can further elicit and propose possible user requirements. Then turn back to the step one.

Moreover, the above requirements analysis method can be run by an extensible requirements analysis system formed by software program or hardware circuit. The extensible requirements analysis system includes an input unit, a user requirements generating unit, an actor generating unit, a use case diagram generating unit, and an output unit. The input unit is used to input user requirements for software system setup. The user requirements are converted by an input format conversion unit to be read by the system. The user requirements can be objects in a form of tables, figures or documents. The input format conversion unit converts the user requirements into various file formats such as Extensible Markup Language (XML), unified modeling language (UML), Portable Document Format (PDF) that can be read by the system. The user requirements generating unit collects user requirements with breadth and depth by a breadth analysis module and a depth analysis module in turn according to users' needs. The actor generating unit finds out actors that interact with the software system according to the users' requirements and further collets actors with breadth and depth by the breadth analysis module and the depth analysis module in turn. As to the use case diagram generating unit, it is for receiving the user requirements from the user requirements generating unit and the actors from the actor generating unit to produce a use case diagram of each actor that uses the actor as a center and interacts with the software system. Then the use case diagrams are modified by the breadth analysis module and the depth analysis module in turn so as to make the use case diagrams have breadth and depth. The output unit receives each use case diagram from the use case diagram generating unit and converts the use case diagrams into preset formats by an output format conversion module. The output format conversion module converts the use case diagram into various file formats including XML, UML, PDF, etc. to be read by software that supports these formats. Thereby the requirements analysis system of the present invention allows the user requirements to be collected quickly at the requirements analysis and requirements definition stages. Moreover, the user requirements are also defined precisely and rapidly. Thus standard operation procedures at the requirements analysis and requirements definition stages of the software system are set up. Once the standard operation procedures are applied to the software industry, the software development efficiency is increased, the development cost is reduced and the problem of rapid changes of users' requirements with the rapidly changing business environment nowadays is also solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of an embodiment of a highly extensible requirements analysis method according to the present invention;

FIG. 2 is a block diagram showing structure of a highly extensible requirements analysis system according to the present invention.

### DETAILED DESCRIPTION OF THE PREFERRED EMBODIMENT

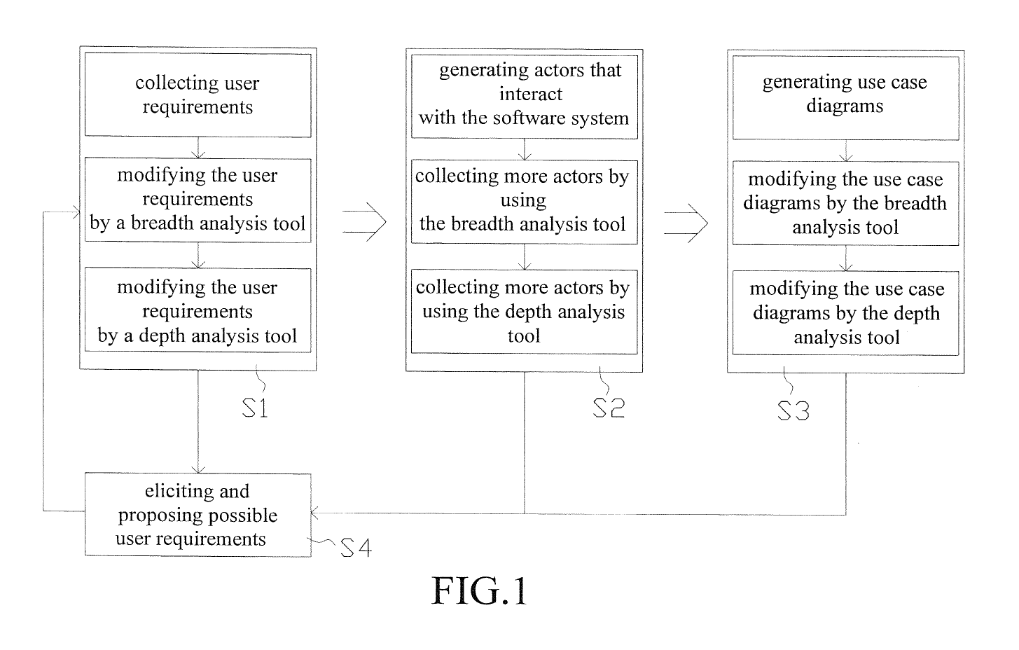

Refer to FIG. 1, a highly extensible requirements analysis method of the present invention includes following steps.

Step one (S1): Collect user requirements of a software system to be set up and modify the user requirements by a breadth analysis tool and a depth analysis tool in turn so that the user requirements are with breadth and depth. The breadth analysis tool is based on a PMI (Plus, Minus, and Interesting) method. PMI is thinking strategy used in de Bono's CoRT thinking program. PMI help analysts to see positive, negative and interesting sides of a strategy to eliminate the immediate acceptance or rejection of the strategy. It also makes the analyst to view things from different points of view. The in-depth analysis tool is based on APC approach. APC stands for: Alternatives, Possibilities, and Choices. The APC is a process trying to find alternatives beyond the obvious options. For example, if there are two options. The obvious choices are not always the best choices. In these situations, analysts focus on exploring all the alternatives, choices or possibilities beyond the obvious ones by their imaginations. That means take a third option no matter its reliability is low or high.

For example, a user can log in a general software system (such as e-mail system, student's e-learning system, etc.) with his account and the corresponding password. Undoubtedly, this is a normal and expected behavior of the system when the user is describing his requirements. After being analyzed by PMI, it is belonging to plus flow. However, the user might forget his password to the account in practice and he can request to reset his password from the account manager. Such abnormal condition can be assigned to a minus one by PMI. Moreover, the analysts propose another two requirements of the above user requirements: “the first-time login” and “account unregistered” by APC. Thereby the analysts can raise questions related to unexpected conditions actively and communicate with users so as to deal with abnormal and unexpected conditions of the system. The PMI and APC mentioned above are already known to people skilled in the art.

Step two (S2): Generate actors that interact with the software system according to the user requirements completed in the step S1. Then use the breadth analysis tool and the depth analysis tool in turn to collect more actors so that the actors are with breadth and depth. The actors can be selected from users of the software system or an external system. For example, in the above student's e-learning system, the common user requirement is “students can login to the e-learning system” and this is an expected function. The analyst can consider the requirement as plus flow by PMI. Then the analyst can propose an extra condition that students might forget his password during login system period by APC. Thus besides students, the actors further include teachers and managers. Thereby requirements of different actors are collected, classified and analyzed to be converted into system specification required for system development.

Step three (S3): Generate use case diagrams of respective actor that show interaction of the actor with the software system according to the user requirements completed in the step S1, and the actors in the step S2. The actor is a center of the use case diagram. Then the use case diagrams are modified by the breadth analysis tool and the depth analysis tool in turn so as to make the use case diagrams have breadth and depth.

After completing the above steps S1 to S3, possible user requirements are further elicited and proposed by the analyst. After completing the step S4, turn back to the step S1. The step S4 can also be taken after completing a single step or at least two steps according to the analyst's needs.

Moreover, the steps of the above highly extensible requirements analysis method can be executed by various software or hardware systems.

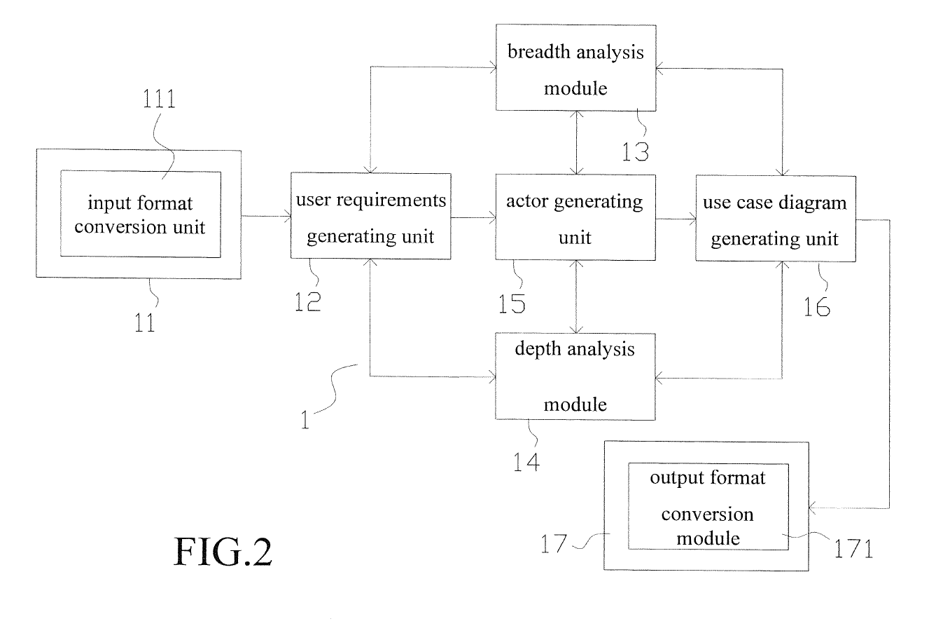

Refer to FIG. 2, a highly extensible requirements analysis system 1 of the present invention includes an input unit 11, a user requirements generating unit 12, a breadth analysis module 13, a depth analysis module 14, an actor generating unit 15, a use case diagram generating unit 16, and an output unit 17.

The user requirements required for software system setup are input through the input unit 11 and are converted by an input format conversion unit 111 to be read by the system. The user requirements can be objects in a form of tables, figures or documents. The input format conversion unit 111 converts the user requirements into various file formats such as Extensible Markup Language (XML), unified modeling language (UML), Portable Document Format (PDF) that can be read by the system.

The user requirements generating unit 12 collects user requirements with breadth and depth by the breadth analysis module 13 and the depth analysis module 14 in turn according to users' needs. The breadth analysis module 13 and the depth analysis module 14 are respectively based on PMI and APC.

The actor generating unit 15 finds out actors that interact with the software system according to the user requirements and further collets actors with breadth and depth by the breadth analysis module 13 and the depth analysis module 14 in turn.

The use case diagram generating unit 16 is for receiving the user requirements from the user requirements generating unit 12 and the actors from the actor generating unit 15 to produce a use case diagram of each actor. The use case diagram uses each actor as a center and shows interaction of the actor with the software system. Then the use case diagrams are modified by the breadth analysis module 13 and the depth analysis module 14 in turn so as to make the use case diagrams have breadth and depth.

The output unit 17 receives each use case diagram from the use case diagram generating unit 16 and converts the use case diagrams into preset formats by an output format conversion module 171. The output format conversion module 171 converts the use case diagram into file formats such as XML, UML, PDF, etc. to be read by software that supports these formats.

The highly extensible requirements analysis method of the present invention is able to be applied to various software, hardware, or their combinations. A part of the method of the present invention can be embedded into executable instruction of computer readable medium (code). The computer readable medium includes electrical transmission module (electronic medium) with at least one cable, portable computer disk (magnetic medium), Random Access Memory (RAM, electronic medium), Read Only Memory (ROM, electronic medium), Erasable Programmable Read Only Memory (EPROM)/Electrically Erasable Programmable Read Only Memory (EEPROM)/Flash Memory (electronic medium), optical fiber (optical medium), Compact Disc Read-Only Memory (CDROM), etc. When the code is loaded into and executed by a device (such as a computer), the device becomes a system that executes the highly extensible requirements analysis method of the present invention. The computer generally includes a processor, a processor-readable storage medium (having volatile memory, non-volatile memory and/or storage element), at least one input device and at least one output device on the condition that the code is executed by a programmable computer.

In summary, compared with techniques available now, the present invention has following advantages:

1. Based on requirements analysis method with three steps available now, the breadth analysis tool (module) and the depth analysis tool (module) of the three-dimensional requirements analysis method of the present invention are used to actively elicit abnormal conditions and unexpected user requirements at each step so as to solve the problem of the conventional single dimension analysis method that only technical features and functions appeared most frequently on the documents or during discussion can be found out. Thus the analyst can understand the user requirements precisely so as to reduce modification frequency of the software system and lower the development cost.
2. A requirements analysis system of the present invention is set up by the highly extensible requirements analysis method. Thus the user requirements are collected quickly and defined precisely at the requirements analysis and requirements definition stages of the software system development so as to set up standard operation procedures at these stages. By applying the standard operation procedures to software industry, the software development efficiency is increased, the development cost is reduced and the problem of rapid changes of users' requirements with the rapidly changing business environment nowadays is also solved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A highly extensible requirements analysis method comprising the steps of:
step one: collecting user requirements of a software system and modifying the user requirements by a breadth analysis tool and a depth analysis tool in turn so as to make the user requirements have breadth and depth;
step two: generating actors that interact with the software system according to the user requirements completed in the step one and then collecting more actors by using the breadth analysis tool and the depth analysis tool in turn so that the actors are with breadth and depth; and
step three: generating use case diagrams of respective actor according to the user requirements completed in the step one, and the actors in the step two and then modifying the use case diagrams by the breadth analysis tool and the depth analysis tool in turn so as to make the use case diagrams have breadth and depth.

2. The method as claimed in claim 1, wherein the breadth analysis tool is based on a PMI (Plus, Minus, and Interesting) method.

3. The method as claimed in claim 1, wherein the depth analysis tool is based on APC (Alternatives, Possibilities, and Choices) method.

4. The method as claimed in claim 1, wherein the method further includes a step four: eliciting and proposing possible user requirements.

5. The method as claimed in claim 4, wherein the step four is run after completing the step one and then turn back to the step one after completing the step four.

6. The method as claimed in claim 4, wherein the step four is run after completing the step two and then turn back to the step one after completing the step four.

7. The method as claimed in claim 4, wherein the step four is run after completing the step three and then turn back to the step one after completing the step four.

8. A highly extensible requirements analysis system comprising:
an input unit that is used to input user requirements required for a software system and having an input format conversion unit that converts the user requirements to be read by the system; the user requirements are objects in a form of tables, figures or documents;
a user requirements generating unit that collects user requirements with breadth and depth by a breadth analysis module and a depth analysis module in turn;
an actor generating unit that finds out actors interacting with the software system according to the users' requirements and further collets actors with breadth and depth by the breadth analysis module and the depth analysis module in turn;
a use case diagram generating unit for receiving the user requirements from the user requirements generating unit and the actors from the actor generating unit to produce use case diagrams of each of the actors; then the use case diagrams are modified by the breadth analysis module and the depth analysis module in turn so as to make the use case diagrams have breadth and depth; and
an output unit for receiving each of the use case diagrams from the use case diagram generating unit and having an output format conversion module for converting the use case diagrams into preset formats.

9. The system as claimed in claim 8, wherein the breadth analysis module is based on PMI.

10. The system as claimed in claim 8, wherein the depth analysis module is based on APC.

11. The system as claimed in claim 8, wherein formats involved in conversion of the input format conversion unit and conversion of the output format conversion module include Extensible Markup Language (XML), unified modeling language (UML), and Portable Document Format (PDF).
